(19) United States
(12) Patent Application Publication
(10) Pub. No.: US 2010/0112954 A1
(43) Pub. Date: May 6, 2010

(54) METHOD OF AND MODULE FOR DETECTING ELECTROMAGNETIC WAVES OF ILLEGAL WIRELESS DEVICES, AND MOBILE DEVICE WITH ELECTROMAGNETIC WAVE DETECTING FUNCTION USING THE SAME

(76) Inventor: Ho Won Son, Busan (KR)

Correspondence Address: PARK LAW FIRM, 3255 WILSHIRE BLVD, SUITE 1110, LOS ANGELES, CA, 90010, US

(21) Appl. No.: 12/515,931

(22) PCT Filed: Nov. 12, 2007
(86) PCT No.: PCT/KR07/05669

§ 371 Date: May 21, 2009

(30) Foreign Application Priority Data
Nov. 28, 2006 (KR) 10-2006-0118123
May 8, 2007 (KR) 10-2007-0044667

(51) Int. Cl. H04B 17/00

(52) U.S. Cl. 455/67.7

(57) ABSTRACT

The present invention provides a radio wave detection method and a radio wave detection module for detecting illegal radio devices, and a mobile device having a radio wave detection function using the method and the module, for effectively detecting a radio signal transmitted from an illegal radio device, such as an eavesdropping device, a monitoring device, and a hidden camera used to violate privacy or leak information. In the present invention, a narrowband radio signal including a radio signal of a frequency band used by the illegal radio device is received through a single frequency antenna, and a direct current voltage value for a specific frequency of the illegal radio device is obtained by serially processing the received narrowband radio signal. Then, the obtained direct current voltage value is transmitted to a micro-controller through an analog-to-digital converter port of the micro-controller, and a data value of a digital form is outputted from the micro-controller to externally display existence of the illegal radio device through a display apparatus.

### TECHNICAL FIELD

The present invention relates to a radio wave detection method and a radio wave detection module for detecting illegal radio devices, and a mobile device having a radio wave detection function using the method and the module, and more specifically, to a radio wave detection method and a radio wave detection module for detecting illegal radio devices, and a mobile device having a radio wave detection function using the method and the module, for effectively detecting a radio signal transmitted from an illegal radio device, such as an eavesdropping device, a monitoring device, or a hidden camera used to violate privacy or leak information.

### BACKGROUND ART

Recently, as eavesdropping devices, monitoring devices, and hidden cameras are illegally used, privacy of an individual and human rights are so frequently and seriously violated as to become a social problem.

At this point, devices such as eavesdropping devices, monitoring devices, and hidden cameras receive and transmit information in a radio communication method by nature, and each country regulates the devices to use a radio wave of a frequency band different from that of general communication equipment. That is, eavesdropping devices and monitoring devices distributed in the market do not use a plurality of unspecific frequency bands as a frequency band. For example, Information and Communication Department in Korea allocates four bands of 2410 MHz, 2430 MHz, 2450 MHz, and 2470 MHz as image transmission bands, which are called as ‘Specific low power radio station frequencies’ for ‘radio transmission image devices’ used as a hidden camera. Therefore, most of products using the ‘radio transmission image devices’ distributed in Korea use frequencies of the four bands. Here, since a unidirectional voice transmission frequency is not allocated for wireless eavesdropping devices among low power radio devices in Korea, the most actively distributed products in Korea are Japanese radio transmitters. Then, Japan regulates frequency bands of radio transmitters to 398.605 MHz, 399.455 MHz, and 399.030 MHz.

Accordingly, as a method for detecting an eavesdropping device, monitoring device, and hidden camera using such a radio communication method, a radio signal of a frequency band used by these devices is extracted from a broadband radio signal to determine existence of the eavesdropping device, monitoring device, or hidden camera.

“Hidden camera detection apparatus” of Korea Laid-open Patent Gazette Publication No. 10-2001-0026373 proposes a technique for detecting hidden cameras operating in the neighborhood, in which the hidden camera detection apparatus comprises a detection unit for detecting external signals, a signal amplification unit electrically connected to the detection unit, for amplifying signals outputted from the detection unit, an alarm unit for generating alarm sounds, and a control unit electrically connected to the signal amplification unit and the alarm unit, for controlling signals outputted from the signal amplification unit to operate the alarm unit.

“Eavesdropping device/Hidden camera detection apparatus” of Korea Patent Gazette Registration No. 10-0552116 proposes a technique for detecting eavesdropping devices and hidden cameras of a variety of frequency bands, in which a low band and a high band antenna for detecting low band and high band RF signals from RF signals are used to detect and analyze signals of a specific frequency by periodically sweeping signals from low frequency of 1.7 MHz to high frequency of 3 GHz.

“Eavesdropping and monitoring device and Hidden camera detector” of Korea Patent Gazette Registration No. 10-0340822 proposes a technique for preventing erroneous operations caused by cellular phone signals, in which the eavesdropping and monitoring device and hidden camera detector comprises a high frequency input unit for receiving high frequency signals generated by eavesdropping and monitoring devices or hidden cameras through an antenna, and a tuning unit for tuning only those signals having frequencies in the range of 80 to 700 MHz among the signals received by the high frequency input unit, in which a precise frequency selection unit for blocking signals in the range of 750 to 850 MHz generated by cellular phones among the frequencies tuned by the tuning unit is installed in the high frequency input unit.

“Radio wave detector for detecting radio waves of hidden cameras and eavesdropping devices” of Korea Utility Model Gazette Registration No. 20-0262547 proposes a technique for obtaining stable signals having very high amplification degree and amplification cut-off frequency without loss of signal transfer by using a super-low noise voltage amplifying field-effect transistor (GaSa MESFET), having a noise figure below 0.7 dB at the frequency of 4 GHz with high input impedance, in a high frequency receiving and amplification unit.

However, the conventional techniques do not provide a clear determination criterion for detecting illegal radio devices, but only provide theoretical techniques for receiving a broadband radio signal and extracting a radio signal of a frequency band used by an illegal radio device, or general techniques for detecting an illegal radio device using a supersonic sensor or the like without regard to acquiring a radio signal. At this point, since a conventional technique proposed to detect an illegal radio device by receiving a radio signal receives a broadband radio signal A as shown in FIG. 1, there is a problem in that it is difficult to detect existence of an illegal radio device stably and effectively. That is, according to the conventional technique, existence of an illegal radio device is determined through a narrowband radio signal B including a radio signal of a frequency band used by the illegal radio device, and there is a problem in that such a narrowband radio signal is overlapped with frequencies used by other devices, as well as with a specific frequency of the illegal radio device, as shown in FIG. 1. For example, wireless eavesdropping devices and a trunked radio system (TRS) use a frequency band of 400 MHz, cellular phones use a frequency band of 800 MHz, cordless phones use a frequency band of 900 MHz, hidden cameras, CCTVs, and the like use a frequency band of 2400 to 2470 MHz, and wireless LAN and Blue tooth use a frequency band of 2427 to 24000 MHz, and thus a narrowband radio signal (conventionally, a technique for detecting illegal radio devices extracts a frequency band corresponding to “B” of FIG. 1 to determine existence of an illegal radio device) includes radio signals (frequencies) of a variety of devices.

Accordingly, according to conventional techniques, a criterion for determining existence of an illegal radio device is not clear and ineffective, and thus there is a problem in that the configuration of an apparatus for accurately separating and processing a radio signal of a frequency band used by an illegal radio device is so complex when the apparatus is implemented that the apparatus cannot be easily miniaturized. Then, noises or erroneous signals making the apparatus unstable are inputted in the process of separating a narrowband radio signal from a received broadband radio signal and processing the separated narrowband radio signal, and thus there is a problem in that response and detection efficiency for radio signals of illegal radio devices is not so high.

On the other hand, as requests for detection of illegal radio devices are increased, proposed is a variety of mobile devices applied with a function for detecting illegal radio devices, such as an MP3 player, personal digital assistant (PDA), digital camera, Play Station Portable (PSP), calculator, and the like. Particularly, in relation with cellular phones that have settled down as necessities of life, introducing such a technique is actively reviewed. For example, a technique for combining a function for detecting illegal radio devices with a cellular phone is proposed, in a method of adding a function for detecting wireless eavesdropping devices and hidden cameras to a cellular phone and in a method of miniaturizing an apparatus for detecting wireless eavesdropping devices and hidden cameras to associated the function with a cellular phone.

“Cellular phone embedded with apparatus for detecting eavesdropping and monitoring device and hidden camera” of Korea Laid-open Patent Gazette Publication No. 2001-0103469 proposes a cellular phone capable of detecting eavesdropping and monitoring devices and hidden cameras, in which a detector reception module for receiving air frequencies of eavesdropping and monitoring devices and hidden cameras and generating warning signals is added to a general cellular phone, and a micro-processor, battery power, amplifier, and speaker of the cellular phone of its own are shared as a warning means. The cellular phone also comprises a mode selector switch for separating or connecting the detector reception module depending on an operation mode, and an external switch for arbitrarily blocking battery power supplied to the detector reception module.

“Cellular phone having a function for detecting hidden cameras and eavesdropping devices” of Korea Patent Gazette Publication No. 2002-0016703 proposes a technique for splitting a signal received through the antenna of a cellular phone into a signal of a frequency band of the cellular phone and a signal of a frequency band of hidden cameras and eavesdropping devices, receiving and detecting the signal of a frequency band of hidden cameras and eavesdropping devices, detecting intensity of an outputted signal, and determining installation of a hidden camera or an eavesdropping device based on the detected signal intensity.

“Apparatus for detecting eavesdropping devices and hidden cameras using mobile communication terminal” of Korea Patent Gazette Publication No. 10-2006-0012938 proposes a technique for detachably connecting a detection module for detecting eavesdropping devices and hidden cameras to a mobile communication terminal so that the detection module can be used whenever desired.

However, such conventional techniques related to a cellular phone providing a function for detecting illegal radio devices apply a method of receiving a broadband radio signal and separating a narrowband radio signal to determine existence of an illegal radio device in the same manner as other conventional techniques, and thus have the same problems. In addition, a detection module is configured in order to apply a function for detecting illegal radio devices to a cellular phone. However, as described above, an apparatus for accurately separating and processing a radio signal of a frequency band used by an illegal radio device is difficult to implement, and thus the apparatus is difficult to be practically applied to a small and thin cellular phone. For example, a system micro-controller (referring to a microcomputer used for general system control, such as an MPU or a CPU) is applied to a cellular phone in order to implement a variety of functions of the cellular phone, and such a system micro-controller has a limited number of analog-to-digital converter ports (ADC ports) compared with the number of input-output ports (IO ports) and has a limitation in applying elements, which need to be installed to perform a detection function for detecting illegal radio devices, due to a circuit board having a limited space and structure, and thus there is a problem in that capacity of the system micro-controller needs to be enhanced. Furthermore, since a cellular phone according to such a conventional technique receives a radio signal of an illegal radio device through an antenna installed for performing communication functions, noises or erroneous signals are inputted even while transmission and receiving signals for communication are processed, and thus there is a problem in that original functions of the cellular phone, including communication functions, are degraded. Therefore, there is a problem in that when the original functions of the cellular are used, particularly, when the original functions of the cellular are used in a communication that practically needs a detection function for detecting illegal radio devices, the detection function for detecting illegal radio devices cannot be used.

### DISCLOSURE OF INVENTION

### Technical Problem

Accordingly, the present invention has been made in order to solve the above problems, and it is an object of the invention to provide a radio wave detection method and a radio wave detection module of a new form for detecting illegal radio devices, in which existence of an illegal radio device can be stably and effectively detected compared with a conventional technique.

Another object of the invention is to provide a radio wave detection method and a radio wave detection module of a new form for detecting illegal radio devices, in which a problem of making a device unstable due to noises or erroneous signals inputted while processing a received signal can be effectively removed, thereby enhancing response and detection efficiency for a radio signal of an illegal radio device.

A further object of the invention is to provide a radio wave detection method and a radio wave detection module of a new form for detecting illegal radio devices, in which since the configuration is simplified compared with a conventional technique in implementing an apparatus for detecting the illegal radio devices, the apparatus can be miniaturized, and a function for detecting the illegal radio devices can be easily applied to a mobile device such as a cellular phone.

A further object of the invention is to provide a radio wave detection method and a radio wave detection module of a new form for detecting illegal radio devices, in which since the module for determining existence of an illegal radio device is particularly constructed as an one chip, a function for detecting illegal radio devices can be easily implemented in a mobile device, such as a cellular phone, a digital camera, PDA, and the like.

A further object of the invention is to provide a mobile device of a new form having a radio wave detection function for detecting illegal radio devices, to which the radio wave detection method and the radio wave detection module are applied, so that an illegal radio device can be efficiently detected without deteriorating original functions of the mobile device, unlike a conventional technique.

### Technical Solution

In order to accomplish the above objects of the invention, according to one aspect of the invention, there is provided a radio wave detection method for detecting an illegal radio device that uses a radio signal of a designated frequency band, the method comprising the steps of: receiving a narrowband radio signal including a radio signal of a frequency band used by the illegal radio device through a single frequency antenna, and obtaining a direct current voltage value for a specific frequency of the illegal radio device by serially processing the received narrowband radio signal; transmitting the obtained direct current voltage value to a micro-controller through an analog-to-digital converter port of the micro-controller, and outputting a data value of a digital form from the micro-controller; and externally displaying existence of the illegal radio device through a display apparatus using the outputted data value of a digital form.

In the radio wave detection method for detecting an illegal radio device according to the present invention, the step of obtaining a direct current voltage value for a specific frequency of the illegal radio device comprises the steps of: extracting the radio signal of the frequency band used by the illegal radio device from the narrowband radio signal received through the single frequency antenna, using a band pass filter; and extracting the specific frequency of the illegal radio device through an RF detector from the radio signal extracted through the band pass filter, and converting the extracted frequency into the direct current voltage value that is an electrical signal transmitted to the analog-to-digital converter port of the micro-controller.

In the radio wave detection method for detecting an illegal radio device according to the present invention, the step of externally displaying existence of the illegal radio device through a display apparatus using the outputted data value of a digital form comprises the steps of: transmitting the data value of a digital form outputted from the micro-controller to a system micro-controller through an input-output port (IO port) of the system micro-controller; and externally displaying the data value of a digital form through the display apparatus under a control of the system micro-controller.

According to another aspect of the invention, there is provided a radio wave detection module for detecting an illegal radio device that uses a radio signal of a designated frequency band, the module comprising: a single frequency antenna selected from a group comprising a loop antenna, a micro-strip antenna, and a chip antenna, for receiving a narrowband radio signal including a radio signal of a frequency band used by the illegal radio device; a radio signal processing unit for obtaining a direct current voltage value for a specific frequency of the illegal radio device by serially processing the narrowband radio signal received from the single frequency antenna; and a micro-controller for outputting the direct current voltage value obtained from the radio signal processing unit as a data value of a digital form.

In the radio wave detection module for detecting an illegal radio device according to the present invention, the single frequency antenna, the radio signal processing unit, and the micro-controller are installed to be mounted on a circuit board of a device having a function for detecting the illegal radio device.

In the radio wave detection module for detecting an illegal radio device according to the present invention, the single frequency antenna, the radio signal processing unit, and the micro-controller are formed as a single chip.

In the radio wave detection module for detecting an illegal radio device according to the present invention, the single frequency antenna, the radio signal processing unit, and the micro-controller are formed as a single chip mounted on a chip socket that is installed on a circuit board of a device, which is provided with a separate system micro-controller to have a function for detecting an illegal radio device, to be contact with an IO port of the system micro-controller, so that the data value of a digital form outputted from the micro-controller is inputted into the system micro-controller.

In the radio wave detection module for detecting an illegal radio device according to the present invention, the radio signal processing unit comprises: a band pass filter for extracting the radio signal of the frequency band used by the illegal radio device from the narrowband radio signal received through the single frequency antenna; and an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

According to another aspect of the invention, there is provided a mobile device having a radio wave detection function for detecting an illegal radio device that uses a radio signal of a designated frequency band, the mobile device comprising: a system micro-controller mounted with a program for performing the function for detecting an illegal radio device that uses a radio signal of a designated frequency band, for performing original functions of the mobile device; and a radio wave detection module connected to the system micro-controller to be supplied with power from a battery of the mobile device, for transmitting a result of detecting the illegal radio device to the system micro-controller, wherein the radio wave detection module is provided with a single frequency antenna selected from a group comprising a loop antenna, a micro-strip antenna, and a chip antenna, for receiving a narrowband radio signal including a radio signal of a frequency band used by the illegal radio device.

In the mobile device having a radio wave detection function for detecting an illegal radio device according to the present invention, the radio wave detection module comprises: a band pass filter for extracting a radio signal of a frequency band used by the illegal radio device from the narrowband radio signal received through the single frequency antenna; and an RF detector for extracting the specific frequency of the illegal radio device from the radio signal extracted through the band pass filter, and converting the extracted frequency into a direct current voltage value that is an electrical signal transmitted to an analog-to-digital converter port of the system micro-controller.

In the mobile device having a radio wave detection function for detecting an illegal radio device according to the present invention, the radio wave detection module comprises: a band pass filter for extracting a radio signal of a frequency band used by the illegal radio device from the narrowband radio signal received through the single frequency antenna; and an RF detector for extracting the specific frequency of the illegal radio device from the radio signal extracted through the band pass filter, and converting the extract frequency into a direct current voltage value; and a detection micro-controller for receiving the direct current voltage value obtained by the RF detector through an analog-to-digital converter port, converting the direct current voltage value into a data value of a digital form through an internal operation, and transmitting the data value of a digital form to the system micro-controller through an IO port of the system micro-controller.

In the mobile device having a radio wave detection function for detecting an illegal radio device according to the present invention, the radio wave detection module is formed as a single chip installed in a main body of the mobile device where the system micro-controller is installed.

The mobile device having a radio wave detection function for detecting an illegal radio device according to the present invention further comprises an external line connection terminal connected to the system micro-controller, wherein the radio wave detection module is installed in a constitutional part of the mobile device selected among a group comprising a battery, earphone, microphone, Bluetooth, and memory stick, and thus when the constitutional part of the mobile device is connected to the external line connection terminal, the radio wave detection module is connected to the system micro-controller and performs the function for detecting an illegal radio device.

In the mobile device having a radio wave detection function for detecting an illegal radio device according to the present invention, the radio wave detection module is installed to be mounted on a circuit board of the mobile device.

In the mobile device having a radio wave detection function for detecting an illegal radio device according to the present invention, the single frequency antenna of the radio wave detection module is installed to be formed in a shape of a pattern on an inner surface of a housing of the main body of the mobile device.

### ADVANTAGEOUS EFFECTS

According to a radio wave detection method and a radio wave detection module for detecting illegal radio devices, since a narrowband radio signal including a radio signal of a frequency band used by an illegal radio device is received using single frequency antennas and processed in serial, the illegal radio device can be detected with excellent stability and high response and detection efficiency compared with conventional techniques. Particularly, since a direct current voltage for a specific frequency of the illegal radio device is obtained through a serial process after receiving a narrowband radio signal including a radio signal of a frequency band used by the illegal radio device using single frequency antennas, a problem of making a mobile device unstable due to noises or erroneous signals inputted while processing the received signal can be effectively removed, and thus response and detection efficiency for the radio signal of the illegal radio device can be enhanced. In addition, in implementing an apparatus for detecting illegal radio devices, the present invention can be configured in a form of a module utilizing active elements and passive elements, and the module can be installed in a circuit board or configured as a single chip. Therefore, since the configuration is simplified compared with conventional techniques, the apparatus can be miniaturized, and a function for detecting illegal radio devices can be easily applied to a mobile device such as a cellular phone. In addition, since the present invention can be configured to output a data value of a digital form through the micro-controller (microcomputer) installed in itself, a hardware configuration for detecting a radio signal of an illegal radio device does not need to be additionally configured in a mobile device such as a cellular phone, and thus the present invention is highly compatible with a variety of mobile devices. Particularly, since the radio wave detection module according to the present invention can be configured as a single chip, a wave radio detection function for detecting illegal radio devices can be applied only by adding a configuration (a socket or an external line connection terminal) for combining a radio wave detection circuit to a desired mobile device such as a cellular phone, and thus burdens on designing a desired device to which the present invention is applied can be diminished. Furthermore, unlike conventional techniques, in the present invention, since a module having a radio wave detection function for detecting illegal radio devices can be added while diminishing burdens on designing a module of a mobile device, an illegal radio device can be detected stably and efficiently without deteriorating original functions of the mobile device. Particularly, since single frequency antennas are installed in addition to the antenna of the mobile device and a detection micro-controller for performing the radio wave detection function is configured in addition to the system micro-controller, the radio wave detection function is separated from the original functions of the mobile device to stably and efficiently perform the detection function, and the mobile device can smoothly perform its original functions. In addition, since single frequency antennas are installed in addition to the antenna of the mobile device, it is advantageous in that a modification of design for installing the antennas is not required to a mobile device that does not use an antenna, such as a calculator, digital camera, PSP, and the like.

### BRIEF DESCRIPTION OF THE DRAWINGS

Further objects and advantages of the invention can be more fully understood from the following detailed description taken in conjunction with the accompanying drawings in which:

FIG. 1 is a graph illustrating background techniques and problems of conventional techniques;

FIG. 2 is a view illustrating a radio wave detection method for detecting illegal radio devices according to the technical spirit of the present invention;

FIG. 3 is a graph illustrating an example of a radio wave detection method for detecting illegal radio devices according to a preferred embodiment of the present invention;

FIG. 4 is a view showing a radio wave detection module for detecting illegal radio devices according to the technical spirit of the present invention;

FIG. 5 is a block diagram illustrating a radio wave detection module for detecting illegal radio devices according to a preferred embodiment of the present invention;

FIG. 6 is a view illustrating an example of implementing the radio wave detection circuit for detecting illegal radio devices shown in FIG. 5;

FIG. 7 is a view illustrating another example of implementing the radio wave detection circuit for detecting illegal radio devices shown in FIG. 5;

FIG. 8 is a block diagram illustrating a mobile device having a radio wave detection function for detecting illegal radio devices according to a preferred embodiment of the present invention;

FIG. 9 is a view illustrating an example of implementing a cellular phone as an example of a mobile device having a radio wave detection function for detecting illegal radio devices shown in FIG. 6; and

FIG. 10 is a view illustrating another example of implementing a cellular phone as an example of a mobile device having a radio wave detection function for detecting illegal radio devices shown in FIG. 6.

### BEST MODE FOR CARRYING OUT THE INVENTION

Hereinafter, the preferred embodiments of the present invention will be described in detail with reference to FIGS. 2 to 10 of the accompanying drawings. Furthermore, in FIGS. 2 to 10 of the drawings illustrating the embodiments of the invention, elements having like functions will be denoted by like reference numerals and details thereon will not be repeated.

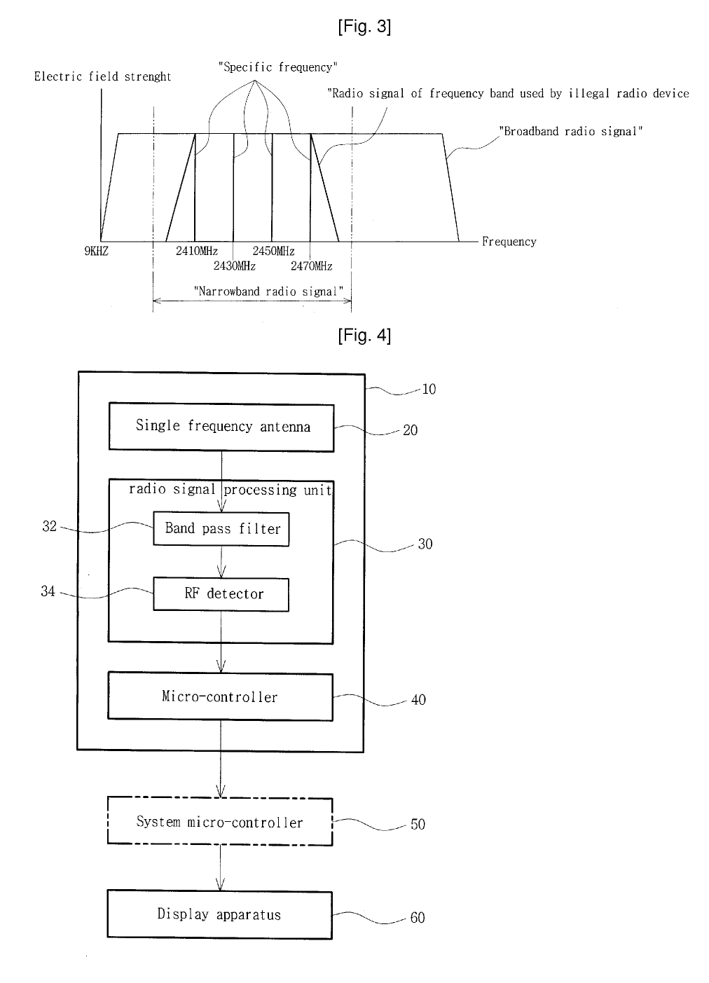

FIG. 2 is a view illustrating a radio wave detection method for detecting illegal radio devices according to the technical spirit of the present invention, FIG. 3 is a graph illustrating an example of a radio wave detection method for detecting illegal radio devices according to a preferred embodiment of the present invention, and FIG. 4 is a view showing a radio wave detection module for detecting illegal radio devices according to the technical spirit of the present invention.

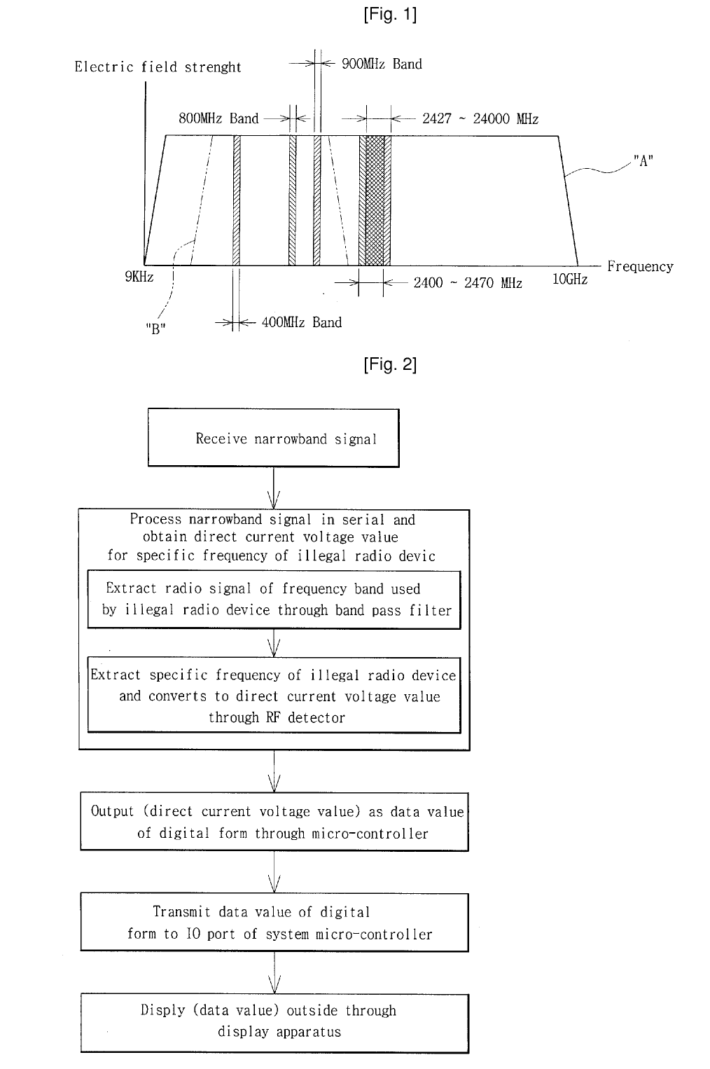

Referring to FIGS. 1 to 4, an object of the present invention is to detect illegal radio devices, such as an eavesdropping device, a monitoring device, or a hidden camera, that is maliciously used to violate privacy or leak information using a radio signal of a designated frequency band (hereinafter, referred to as an illegal radio device), and there is provided a radio wave detection method for detecting illegal radio devices and a radio wave detection module comprising constitutional elements for implementing the method.

The radio wave detection method for detecting illegal radio devices according to the present invention receives a narrowband radio signal, processes the narrowband radio signal in serial (continuously processes the narrowband radio signal in a row through a radio signal processing unit 30 comprising a band pass filter 32 and an RF detector 34), obtains a direct current voltage value for a radio signal of a specific frequency, outputs the obtained direct current voltage value as a data value of a digital form, and displays the data value of a digital form outside through a display apparatus 60 (i.e., a display 62, a speaker 64, or a light emitting diode LED shown in FIG. 8), which is processed by a radio wave detection circuit 10 where these steps are configured as a module. At this point, if a micro-controller 40 for outputting the direct current voltage value for a radio signal of a specific frequency as a data value of a digital form is used as a micro-controller of equipment dedicated for detecting illegal radio devices or of a mobile device of its own, the display apparatus 60 is controlled by the micro-controller 40, whereas if the radio wave detection module of the present invention formed to be easily installed in a mobile device is configured as a single chip or an independent module, the display apparatus 60 is controlled by a system micro-controller 50 (e.g., a system micro-controller 50 of a cellular phone 100 in the present invention) of the mobile device to externally display the data value of a digital form.

Describing in detail referring to FIGS. 1 to 4, a narrowband radio signal including a radio signal of a frequency band used by an illegal radio device is received through a single frequency antenna 20. Accordingly, compared with a conventional method of receiving an unspecific radio signal (a broadband radio signal) using an antenna having a reception rate of a plurality of comparatively wide frequency bands, the radio wave detection method is a method of receiving a radio signal of a frequency band used by an illegal radio device. Therefore, a specific radio signal is selectively received and simply processed, and thus a compact radio wave detection circuit can be configured.

The narrowband radio signal received as such is serially processed, and a direct current voltage value for the specific frequency band of the illegal radio device is obtained. At this point, the direct current voltage value is obtained by extracting a radio signal of a frequency band used by the illegal radio device through the band pass filter 32, extracting a specific frequency of the illegal radio device through the RF detector 34, and converting the radio signal of the extracted specific frequency into the direct current voltage value. That is, the direct current voltage value for a specific frequency of an illegal radio device is obtained through the steps of extracting a radio signal of a frequency band used by the illegal radio device from the narrowband radio signal received through the single frequency antenna 20 through the band pass filter 32, extracting a specific frequency of an illegal radio device through the RF detector, and converting the radio signal of the extracted specific frequency into the direct current voltage value, which is an electrical signal transmitted to an analog-to-digital port of the micro-controller 40.

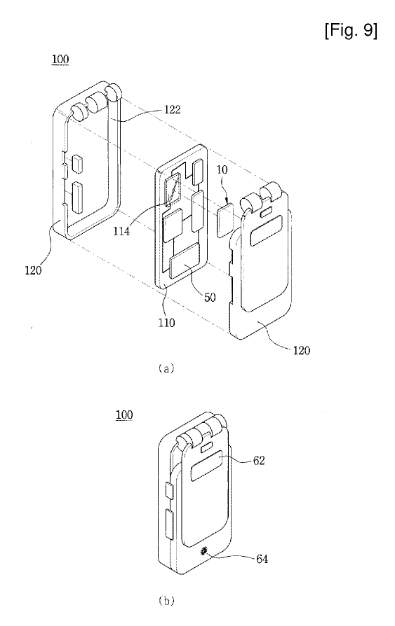

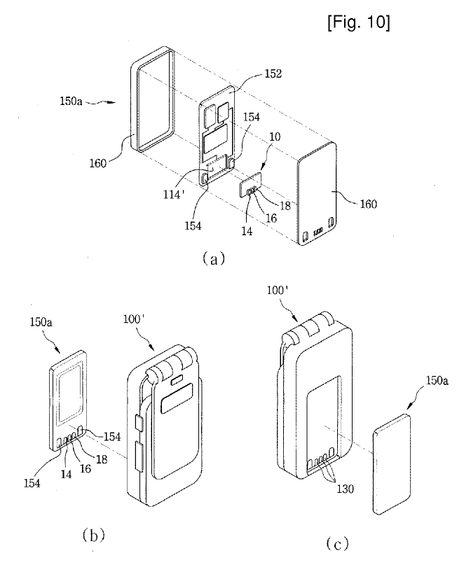

The direct current voltage value for a specific frequency of an illegal radio device obtained as such is outputted as a data value of a digital form through the micro-controller 40. That is, the micro-controller 40 outputs the voltage (direct current voltage value) flowing into the ADC port through the RF detector 34 as a code of a digital form through an operation process set in the micro-controller. At this point, the method of outputting the direct current voltage value as a data value of a digital form using the micro-controller 40 of the present invention can be easily applied to the mobile device 100 such as a cellular phone 100 and 100′ (refer to FIGS. 9 and 10) that will be described below, particularly if the method is implemented in a single chip. That is, according to a conventional technique, when a separate apparatus having a radio wave detection function (generally, a detector) is implemented, or the radio wave detection function is added to a mobile device such as a cellular phone, they should be designed using the ADC port of the micro-controller (corresponding to the system micro-controller 50 of the present invention) of the mobile device 100. Therefore, the ADC port should be reflected from the initial design of the cellular phone, and the radio wave detection function for detecting illegal radio devices should be additionally reflected when an operation program of the cellular phone is created. Contrarily, according to the present invention, since the micro-controller 40 outputs a code of a digital form and uses an I/O port of the system micro-controller 50 of the mobile device 100, the radio wave detection function for detecting illegal radio devices can be applied to the mobile device 100, such as the cellular phone 100 and 100′, only through software upgrade (a general method of installing and using a program in a cellular phone), without a need of additional hardware configuration (needless to say, a chip socket 114 (refer to FIG. 9) combined and connected to the radio wave detection module 10 according to the present invention or an external line connection terminal 130 (refer to FIG. 10) needs to be configured). Needless to say, the radio wave detection module that implements the radio wave detection function for detecting illegal radio devices of the present invention described above is implemented to be installed on a circuit board in the form of an active element or a passive element, and a micro-controller (referred to as a system micro-controller 50 in the present invention) installed for performing original functions of a general mobile device can be used as the micro-controller 40 for outputting the code of a digital form.

As described above, in the radio wave detection method for detecting illegal radio devices according to the present invention, the step of receiving a narrowband radio signal including a radio signal of a frequency band used by an illegal radio device and obtaining a direct current voltage value for a specific frequency of the illegal radio device, and the step of outputting a data value of a digital form are performed by the radio wave detection circuit 10 comprising the single frequency antenna 20, the radio signal processing unit 30, and the detection micro-controller 40, and existence of an illegal radio device is externally displayed through the display apparatus 60 using the data value of a digital form. Here, an LED or LCD display, a buzzer, a speaker, or the like can be applied as the display apparatus 60, and if a device dedicated for detecting illegal radio devices (detector) or the system micro-controller 50 is used as the micro-controller 40 for outputting the data value of a digital form, the data value is transmitted under the direct control of the micro-controller 40. Then, in the case of the mobile device 100, such as a cellular phone, additionally provided with the radio wave detection function for detecting illegal radio devices, the data value of a digital form is outputted to the I/O port of the system micro-controller 50 (e.g., a system micro-controller of a cellular phone) installed outside of the radio wave detection circuit 10 configured as a module, and the data value of a digital form is externally displayed through a display apparatus (as shown in FIG. 9, the display 62 or the speaker 64 of the cellular phone 100) under the control of the system micro-controller 50.

Referring to FIG. 4, the radio wave detection module 10 for detecting illegal radio devices according to the present invention comprises a single frequency antenna 20, a radio signal processing unit 30, and a micro-controller 40 in order to implement the radio wave detection method for detecting illegal radio devices as describe above, and outputs a result of determining existence of an illegal radio device as a data value of a digital form with respect to a specific frequency.

Describing in further detail, the single frequency antenna 20 can be configured selectively using a loop antenna, a micro strip antenna, a chip antenna, or the like in order to receive a narrowband radio signal including a radio signal of a frequency band used by an illegal radio device. Such a single frequency antenna 20 is configured to receive radio signals limited to a radio signal of a specific band including a radio signal of a frequency band used by the illegal radio device, unlike a general antenna that receives an unspecific radio signal or a radio signal of a wide range. The radio signal processing unit 30 processes the narrowband radio signal received from the single frequency antenna 20 in serial and obtains a direct current voltage value for a specific frequency of the illegal radio device. In the present invention, such a radio signal processing unit 30 comprises a band pass filter 32 and an RF detector 34. Here, the band pass filter 32 extracts a radio signal of a frequency band used by the illegal radio device from the narrowband radio signal received from the single frequency antenna 20, and the RF detector 34 extracts a specific frequency of the illegal radio device from the radio signal extracted through the band pass filter 32 and converts the radio signal of the extracted frequency into a direct current voltage value, which is an electrical signal transmitted to the analog-to-digital converter port of the micro-controller 40.

As described above, the radio wave detection module 10 of the present invention is provided with the micro-controller 40 for outputting the direct current voltage value for a specific frequency of the illegal radio device obtained by the radio signal processing unit 30 as a data value of a digital form, and obtains a data value that is a result of finally determining existence of an illegal radio device. Accordingly, in the present invention, since a specific radio signal is selectively received and the signal is promptly processed through a simply configured circuit, a high response and detection efficiency for an illegal radio device is secured together with stability. Furthermore, constitutional elements for detecting illegal radio devices can be super-miniaturized, and thus they can be easily embedded in a mobile device such as a cellular phone.

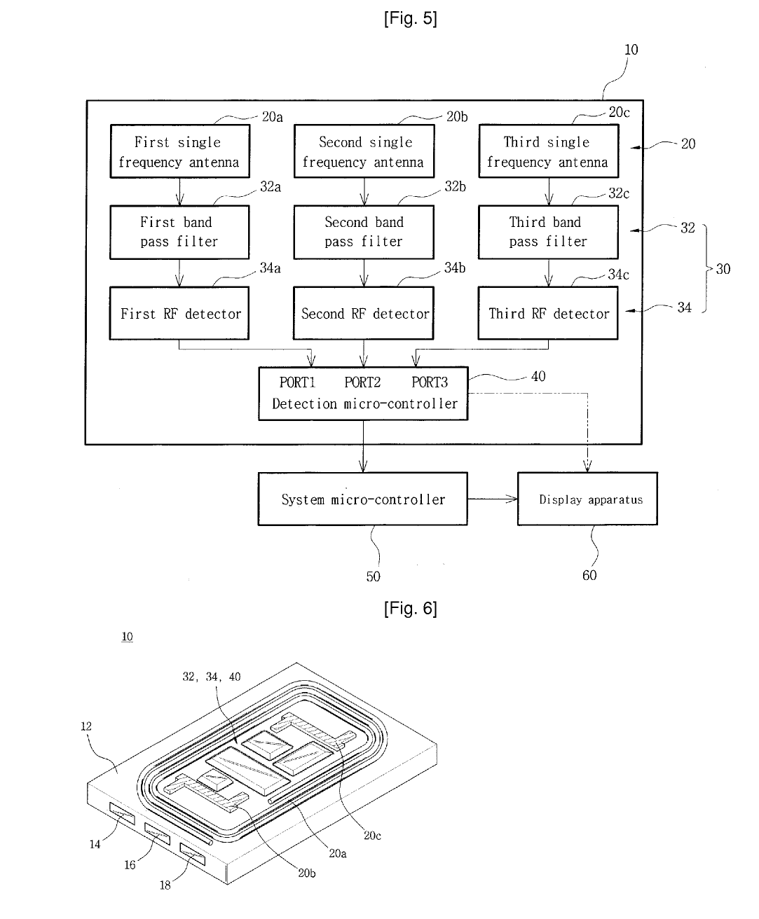

Here, illegal radio devices detected by the present invention include a wireless eavesdropping device, a wireless monitoring device, a hidden camera, and the like, and the present invention is configure to detect only one illegal radio device selected among the above illegal radio devices (such a selection can be controlled by software, or automatically controlled through a serial communication between the detection micro-controller (processor) 40 and the system micro-controller (processor) 50. Alternatively, as shown in FIGS. 5 and 8, a plurality of single frequency antennas 20a, 20b, and 20c, band pass filters 32a, 32b, and 32c, and RF detectors 34a, 34b, and 34c are installed, and two or more of the single frequency antennas, band pass filters, and RF detectors selected among them (in software) simultaneously detect two or more illegal radio devices. Needless to say, as described above, according to the present invention, if the radio wave detection module 10 is configured as a single chip, the configuration can be simply modified when needed by replacing the radio wave detection module and upgrading software. For example, when a cellular phone, mounted with the radio wave detection module for detecting illegal radio devices, used in Korea is to be used in Japan, it is possible to replace the radio wave detection module with a radio wave detection module designed to detect an illegal radio device of a specific frequency applied in Japan.

FIG. 5 is a block diagram illustrating a radio wave detection module for detecting illegal radio devices according to a preferred embodiment of the present invention.

Referring to FIG. 5, the radio wave detection module 10 for detecting illegal radio devices according to a preferred embodiment of the present invention uses three single frequency antennas 20 for receiving a radio signal of a specific frequency band used by an illegal radio device respectively, i.e. a first single frequency antenna 20a, a second single frequency antenna 20b, and a third single frequency antenna 20c. A receive narrowband radio signal is serially processed by the radio signal processing unit 30 and outputted as a data value of a digital form through the detection micro-controller 40, and thus constitutional elements are miniaturized with high stability. That is, since a conventional radio wave detection apparatus for detecting illegal radio devices receives an unspecific radio signal through an antenna and removes the unspecific signal through an internal circuit of the radio wave detection apparatus, noises or erroneous signals are frequently inputted in the process of correctly separating and processing a radio signal of a specific frequency band transmitted by an illegal radio device, and therefore, the apparatus is unstable, and the response and detection efficiency for the radio signal of the illegal radio device is not so high. Contrarily, in the present invention, as described above, since a radio signal limited to a specific frequency used by an illegal radio device is received from the step of receiving the radio signal, the problem of noises or erroneous signals inputted while processing the signal is minimized, and thus excellent stability and high response and detection efficiency can be obtained. Particularly, since the single frequency antenna 20 for receiving a radio signal of an illegal radio device is installed in addition to a (communication) dedicated antenna, such as an antenna of a cellular phone, the problem of noises or erroneous signals inputted while processing the signal can be removed compared with conventional techniques, and the radio wave detection function for detecting illegal radio devices can be quite easily installed in a mobile device that does not have a dedicated antenna, such as a digital camera.

At this point, as it is noted, the illegal radio devices include a wireless eavesdropping device, a wireless monitoring device, a hidden camera, and the like, and generally, the wireless eavesdropping device, wireless monitoring device, and hidden camera do not use a unspecific many frequency band as a frequency band. That is, in Korea, the frequency band of a radio transmission image device used as a hidden camera is limited to four bands of 2410 MHz, 2430 MHz, 2450 MHz, and 2470 MHz for image transmission, which is called as a frequency for specific low power radio station, and thus radio transmission image devices in Korea use frequencies of the four bands. Then, in Japan, the frequency band of a radio transmission image device is limited to 1200 MHz. Accordingly, the second and third single frequency antennas 20b and 20c that respectively receive a radio signal of frequency bands of 1.2 GHz and 2.4 GHz are used to detect a hidden camera. At this point, since the frequency band of a radio transmitter is limited to 400 MHz in Japan, the first single frequency antenna 20a that receives a radio signal of a frequency band around 400 MHz is used to detect a wireless eavesdropping device.

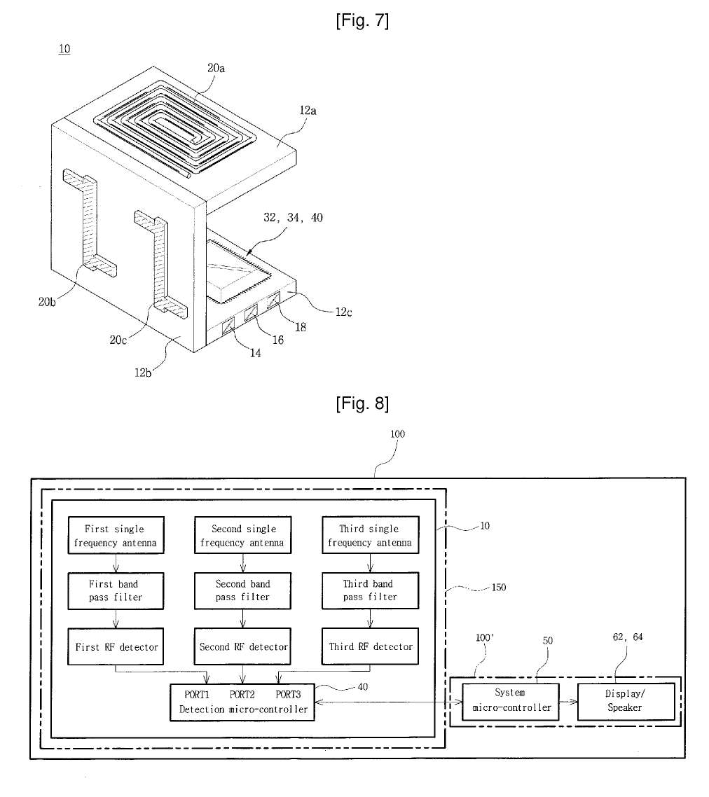

On the other hand, the radio wave detection module 10 according to a preferred embodiment of the present invention applies the first single frequency antenna 20a, the second single frequency antenna 20b, and the third single frequency antenna 20c that respectively receive a radio signal of frequency bands around 400 MHz, 1.2 GHz, and 2.4 GHz in order to have a function for detecting both of the wireless eavesdropping device and the wireless monitoring device. Particularly, the first single frequency antenna 20a, as shown in FIGS. 6 and 7, applies a loop antenna for receiving a radio signal including 400 MHz to detect a wireless eavesdropping device that uses a frequency band around 400 MHz, and the second and third single frequency antennas 20b and 20c apply a micro strip antenna or a chip antenna for receiving a radio signal of a frequency band of 1.2 GHz to detect a hidden camera that uses a frequency band around 1.2 GHz and 2.4 GHz, which is higher than that of the first single frequency antenna 20a. Needless to say, although all of the first, second, and third single frequency antennas 20a, 20b, and 20c for a receiving radio signal of frequency bands of 400 MHz, 1.2 GHz, and 2.4 GHz are applied in the preferred embodiment of the present invention, the number and types of such single frequency antennas can be changed as needed. Furthermore, although the first, second, and third single frequency antennas 20a, 20b, and 20c are basically installed as a pattern or an element on a circuit board where the radio wave detection module are configured, they can be applied on the inner surface of the housing of a mobile device considering the trend of miniaturizing mobile devices such as a cellular phone (The first, second, and third single frequency antennas can be configured on the inner surface 122 of the housing 120 configuring the case of the body of the cellular phone 100 as shown in FIG. 9. Such a pattern can be generally configured in the process of forming a shield on the inner surface of a housing 120, and such a manufacturing process is a technique well-known in the art. Since such a pattern can be easily configured with the technique, detailed description thereof will be omitted).

The radio signals received through the first, second, and third single frequency antennas 20a, 20b, and 20c are serially processed through the radio signal processing unit 30 comprising the band pass filter 32 and the RF detector 34, and a direct current voltage value is obtained for a specific frequency band of an illegal radio device. That is, although the radio signal received through the single frequency antenna 20 is a narrowband radio signal having a certain range from the specific frequency used by the illegal radio device compared with a signal received through a general antenna, since the radio signal received through the single frequency antenna is always mixed with noises due to a characteristic of a radio wave signal, the band pass filter 32 for passing through a radio signal of a frequency band (400 MHz, 1.2 GHz, and 2.4 GHz in the present embodiment) used by the illegal radio device is applied to filter unnecessary noises through the band pass filter 32. Then, the radio signal outputted from the band pass filter 32 is received through the RF detector 34, and a specific frequency of the illegal radio device is extracted and converted into a direct current voltage value, which is a signal inputted into the ADC port of the detection micro-controller 40. According to a preferred embodiment of the present invention, the band pass filter 32 of the radio signal processing unit 30 comprises a first band pass filter 32a, a second band pass filter 32b, and a third band pass filter 32c respectively corresponding to and connected to the first single frequency antenna 20a, the second single frequency antenna 20b, and the third single frequency antenna 20c described above, and the RF detector 34 comprises a first RF detector 34a, a second RF detector 34b, and a third RF detector 34c successively connected to the first band pass filter 32a, the second band pass filter 32b, and the third band pass filter 32c in order to serially process the radio signal in association with the band pass filter 32.

On the other hand, in the present embodiment, the detection micro-controller 40 outputs the direct current voltage values applied from the first, second, and third RF detectors 34a, 34b, and 34c through the ADC port as codes (data value) of a digital form through a predetermined operation process, and the outputted codes are transmitted to the system micro-controller 50 of a mobile device to which the present invention is applied, such as a cellular phone. Needless to say, if a detector dedicated for detecting illegal radio devices is used, or the system micro-controller 50 is used as the detection micro-controller 40, the detection micro-controller 40 can directly control a display, LED, buzzer, and the like to externally display the data values. As described above, since a radio signal of an analog form is outputted as a data value of a digital form, the radio wave detection module 10 according to the present invention can be very easily applied to a mobile device such as a cellular phone. That is, according to the present invention, if a data value is outputted, an illegal radio device exists in the neighborhood of a place where radio waves of illegal radio devices are detected, whereas if a data value is not outputted, an illegal radio device does not exist in the neighborhood of a place where radio waves of illegal radio devices are detected. In addition, it is assumed that if magnitude of the outputted signal is gradually increased as the location is moved from the place where radio waves of illegal radio devices are detected, the illegal radio device is getting closer, whereas if magnitude of the outputted signal is gradually decreased as the location is moved from the place where radio waves of illegal radio devices are detected, the illegal radio device is getting farther.

As described above, in the radio wave detection module 10 according to a preferred embodiment of the present invention, since narrowband radio signals received through the first, second, and third single frequency antennas 20a, 20b, and 20c are serially processed through active elements and passive elements configuring the first, second, and third band pass filters and the first, second, and third RF detectors 34a, 34b, and 34c, signal processing is performed in a speedy way compared with conventional techniques in which the received signals are processed by a separate complex circuit structure, such as a detector, amplifier, and the like, and thus response and detection efficiency for an illegal radio device is enhanced, and the radio wave detection module can have excellent stability.

FIG. 6 is a view illustrating an example of implementing the radio wave detection circuit for detecting illegal radio devices shown in FIG. 5, and FIG. 7 is a view illustrating another example of implementing the radio wave detection circuit for detecting illegal radio devices shown in FIG. 3.

Referring to FIGS. 6 and 7, as described above, in the radio wave detection module 10 for detecting illegal radio devices according to a preferred embodiment of the present invention, since constitutional elements can be simplified and minimized, the element configuring the radio wave detection module 10 are integrated to be easily configured in the form of a super-micro element or a chip.

Since such a radio wave detection module 10 can be configured as an independent module of a super-micro size, if it is installed or mounted on the mobile device 100 such a cellular phone 100 and 100′ (refer to FIGS. 9 and 10), input and output of signals are performed independently from original functions of the mobile device. Therefore, signal interference or operation interference accompanied by performing both of the functions are prevented, and the radio wave detection module 10 is standardized as a single chip to be conveniently and simply mounted on the mobile device 100.

Such a radio wave detection module 10 can be modularized in a variety of forms. That is, as shown in FIG. 6, the radio wave detection module can be configured by installing the first, second, and third single frequency antennas 20a, 20b, and 20c, and mounting the elements that configure the band pass filter 32, the RF detector 34, and the detection micro-controller 40 on a circuit board 12 formed as a small thin plate (such a circuit board 12 can be a circuit board for configuring a single chip or a circuit board configuring a mobile device). Alternatively, as shown in FIG. 7, the radio wave detection module can be configured by installing the first, second, and third single frequency antennas 20a, 20b, and 20c, and mounting the elements that configure the band pass filter 32, the RF detector 34, and detection micro-controller 40 on a plurality of circuit boards 12a, 12b, and 12c formed as a multi-layer or a specific structure. Needless to say, the first, second, and third single frequency antennas 20a, 20b, and 20c, the band pass filter 32, the RF detector 34, and the detection micro-controller 40 can be diversely arranged depending on the condition of design, and its wiring can be set based on a technique for configuring a general circuit board. Then, as described above, the first, second, and third single frequency antennas 20a, 20b, and 20c can be configured using a technique for utilizing space, in the form of a shield wrapping around the radio wave detection module 10 or in the form of a pattern within the housing of a mobile device (in the case of the cellular phone 100, the inner side 122 of the housing 120) in which the radio wave detection module 10 is installed.

At this point, in a preferred embodiment of the present, considering the characteristic of an antenna that the length is inverse proportional to the magnitude of a frequency, a loop antenna that can be extended in a narrow space is applied as the first single frequency antenna 20a assigned for wireless eavesdropping devices that transmit radio signals of a 400 MHz frequency band, and a super-thin micro strip or chip antenna, which can be directly installed on the surface of a circuit board, is used as the second and third single frequency antennas 20b and 20c assigned for hidden cameras that transmit radio signals of 1.2 GHz and 2.4 GHz frequency bands. Then, all of the loop antenna, the micro strip antenna, and the chip antenna used as the first, second, and third single frequency antennas 20a, 20b, and 20c in the present invention can be manufactured in a super-micro size, and thus space can be utilized maximally. Needless to say, as described above, if the radio wave detection module 10 is configured to detect only either of the illegal radio devices, i.e., the wireless eavesdropping device or the hidden camera, any one selected among the first, second, and third single frequency antennas 20a, 20b, and 20c can be applied.

Since such a radio wave detection module 10 according to the present invention is embedded with the first, second, and third single frequency antennas 20a, 20b, and 20c, if the radio wave detection module is installed in a mobile device such as a cellular phone to allows a function for detecting illegal radio devices, it will receive only a specific radio signal of a frequency band of a radio signal transmitted by a wireless eavesdropping device or a hidden camera, independently from the antenna of the mobile device. Therefore, according to the present invention, the problem of noises or signal interference of a cellular phone having a conventional radio detection function, which is occurred in the process of simultaneously receiving a communication signal of the cellular phone and a radio signal transmitted by a wireless eavesdropping device or a hidden camera through an embedded antenna, separating the received signal, and processing the separated signal, can be solved.

In addition, if the radio wave detection module 10 of the present embodiment is configured as a single chip, a power terminal 14 in contact with the circuit board 12 for applying power from outside, an output terminal 16 for inputting and outputting data, and a ground terminal 18 are installed, and such a configuration can be set depending on the type of the chip. For example, although the power terminal 14, the output terminal 16, and the ground terminal 18 are installed at one side of the circuit board 12 in FIGS. 6 and 7, if the chip is configured in a pin type or a connector type, a configuration relevant to the type of the chip will be provided.

FIG. 8 is a block diagram illustrating a mobile device having a radio wave detection function for detecting illegal radio devices according to a preferred embodiment of the present invention, FIG. 9 is a view illustrating an example of implementing a cellular phone as an example of a mobile device having a radio wave detection function for detecting illegal radio devices shown in FIG. 6, and FIG. 10 is a view illustrating another example of implementing a cellular phone as an example of a mobile device having a radio wave detection function for detecting illegal radio devices shown in FIG. 6. At this point, FIG. 9 (a) is a view schematically showing a circuit board 110 and a housing 120 of a cellular phone separated from each other, and FIG. 9 (b) is a view showing the circuit board and the housing of FIG. 9 (a) combined with each other. The cellular phone 100 shown in FIG. 9 is an example for specifically describing the present invention and does not limit the technical spirit of the present invention. In addition, FIG. 10 is a view showing a battery 150a as an example among constitutional parts 150 (refer to FIG. 8) of the cellular phone, such as the battery, earphone, microphone, Bluetooth, memory stick, and the like. FIG. 10 (a) is a view schematically showing a disassembled state of the battery 150a, and FIGS. 10 (b) and (c) are views schematically showing the front and rear sides of the battery 150a before the battery is combined with the cellular phone 100. The cellular phone 100 and the battery 150a shown in FIG. 10 are an example for specifically describing the present invention and do not limit the technical spirit of the present invention.

Referring to FIGS. 8 to 10, the radio wave detection module 10 according to the present invention has a modular configuration for detecting illegal radio devices as described above to output a result of detecting illegal radio devices to itself, and thus the radio wave detection module is advantageous in that it can be further easily applied to the mobile device 100 such as a cellular phone. Hereinafter, the mobile device 100 will be described in detail with an example of the cellular phone 100 and 100′.

The cellular phone 100 and 100′ according to the present invention is configured to be applied with the radio wave detection module 10 having the configuration and operation described above to have a radio wave detection function for detecting illegal radio devices using a specific frequency. At this point, the cellular phone 100 and 100′ according to the present invention basically has functions of a general cellular phone, with which the radio wave detection module 10 according to the present invention is electrically contacted in order to transmit a data value of a digital form outputted from the detection micro-controller 40 to the system micro-controller 50 (refer to a microcomputer for controlling the cellular phone 100 and 100′ of the cellular phone 100 and 100′. The system micro-controller 50 has a technical configuration for controlling the display 62, i.e., a display apparatus, or the speaker 64 using the data value of a digital form transmitted from the detection micro-controller 40 to externally display the data value. Needless to say, as describe above, the system micro-controller 50 of the cellular phone 100 and 100′ can be applied as the detection micro-controller 40, and since the detection micro-controller 40 is replaced with the system micro-controller 50, detailed descriptions of the operation according to such a configuration will be omitted.

As a form implementing such a technique, as shown in FIG. 9, the radio wave detection module can be mounted on the circuit board 110 of the cellular phone 100 (in the present embodiment, although the main circuit board on which the system micro-controller 50 is installed is shown, such a circuit board can be applied to other circuit boards) to be installed in the main body of the cellular phone 100. Alternatively, as shown in FIG. 10, the radio wave detection module can be configured such that connection terminals, such as the power terminal 14, the output terminal 16, and the ground terminal 18, are installed in the constitutional part 150 of the cellular phone, such as a battery 150a, earphone, microphone, Bluetooth, memory stick, or the like, connected to the external line connection terminal 130 of the cellular phone 100′. At this point, although a radio wave detection module installed in the battery 150a is shown in FIG. 10 as an example, the radio wave detection module can be installed in other constitutional parts 150 of the cellular phone to configure a variety of forms under the technical spirit of the present invention.

In such a cellular phone 100 and 100′ according to a preferred embodiment of the present invention, a program for performing a radio wave detection function for detecting illegal radio devices using a specific frequency is mounted, and the system micro-controller 50 for performing functions of the cellular phone is basically installed. Then, the radio wave detection module 100 described above is connected to be supplied power from the battery of the cellular phone 100 and 100′ and is in contact with the input and output ports of the system micro-controller 50. The radio wave detection module is installed so as to transmit a data value related to detection of an illegal radio device to the system micro-controller 50.

At this point, as described above, the radio wave detection module 10 can be installed in the main body of the cellular phone 100 as shown in FIG. 9 or in a constitutional part 150 of the cellular phone as shown in FIG. 10.

As shown in FIG. 9, if the radio wave detection module 10 is installed inside the cellular phone 100 to configure the cellular phone 100, a chip socket 114 connected to the input and output ports of the system micro-controller 50 is installed on the circuit board 110 of the cellular phone to be combined with the radio wave detection module 10. Needless to say, as described above, such a chip socket 114 is not limited to the main circuit board on which the system micro-controller 50 is installed, nor the position is limited. For example, recently, there is provided a technique for conveniently attaching and detaching a chipset that has a specific function for enhancing value-added functions through a cellular phone, and the present invention can be implemented in such a form.

In addition, as shown in FIG. 10, if the radio wave detection module 10 is installed in the battery 150a, which is a constitutional part 150 of a cellular phone, to configure the cellular phone 100′, the radio wave detection module 10 can be installed to be combined with a mounting depression 114′ formed on the battery circuit board 152 of the battery 150a and placed within the housing 160. At this point, the connection terminals of the radio wave detection module 10, such as the power terminal 14, the output terminal 16, and the ground terminal 18, are configured separately from the battery terminal 154, and when they are contacted with the external line connection terminal 130 of the main body of the cellular phone 100′, they are connected to the system micro-controller 50 to perform a function for detecting illegal radio devices. Needless to say, such a connection structure can be configured by applying a variety of techniques in the art.

In such a cellular phone 100 and 100′ according to a preferred embodiment of the present invention, the radio wave detection module 10 is connected to the system micro-controller 50 of the cellular phone 100 and 100′, and the radio wave detection module 10 transfers data values of a digital form for radio signals of an illegal radio device to the system micro-controller 50, and the system micro-controller 50 controls to output a detection signal for the illegal radio device to outside of the cellular phone 100 and 100′ through a display apparatus, such as the display 62, the speaker 64, or the like.

Such a cellular phone 100 and 100′ having the radio wave detection function for detecting illegal radio devices according to the present invention performs the detection function, and the detection function for detecting illegal radio devices can be performed only by downloading an application program for outputting the data value of a digital form inputted from the radio wave detection module 10 to the display apparatus of the cellular phone 100 and 100′.

As described above, although a radio wave detection method, a radio wave detection module, and a mobile device having a radio wave detection function using the method and the module have been described referring to figures, but it is merely an example, and it will be readily understood by those skilled in the art that various adaptations and changes can be made thereto without departing from the spirit and scope of the present invention defined by the appended claims.

### MODE FOR THE INVENTION

In order to accomplish the above objects of the invention, according to one aspect of the invention, there is provided a radio wave detection method for detecting an illegal radio device that uses a radio signal of a designated frequency band, the method comprising the steps of: receiving a narrowband radio signal including a radio signal of a frequency band used by the illegal radio device through a single frequency antenna, and obtaining a direct current voltage value for a specific frequency of the illegal radio device by serially processing the received narrowband radio signal; transmitting the obtained direct current voltage value to a micro-controller through an analog-to-digital converter port of the micro-controller, and outputting a data value of a digital form from the micro-controller; and externally displaying existence of the illegal radio device through a display apparatus using the outputted data value of a digital form.

In the radio wave detection method for detecting an illegal radio device according to the present invention, the step of obtaining a direct current voltage value for a specific frequency of the illegal radio device comprises the steps of: extracting the radio signal of the frequency band used by the illegal radio device from the narrowband radio signal received through the single frequency antenna, using a band pass filter; and extracting the specific frequency of the illegal radio device through an RF detector from the radio signal extracted through the band pass filter, and converting the extracted frequency into the direct current voltage value that is an electrical signal transmitted to the analog-to-digital converter port of the micro-controller.

In the radio wave detection method for detecting an illegal radio device according to the present invention, the step of externally displaying existence of the illegal radio device through a display apparatus using the outputted data value of a digital form comprises the steps of: transmitting the data value of a digital form outputted from the micro-controller to a system micro-controller through an input-output port (IO port) of the system micro-controller; and externally displaying the data value of a digital form through the display apparatus under a control of the system micro-controller.

According to another aspect of the invention, there is provided a radio wave detection module for detecting an illegal radio device that uses a radio signal of a designated frequency band, the module comprising: a single frequency antenna selected from a group comprising a loop antenna, a micro-strip antenna, and a chip antenna, for receiving a narrowband radio signal including a radio signal of a frequency band used by the illegal radio device; a radio signal processing unit for obtaining a direct current voltage value for a specific frequency of the illegal radio device by serially processing the narrowband radio signal received from the single frequency antenna; and a micro-controller for outputting the direct current voltage value obtained from the radio signal processing unit as a data value of a digital form.

In the radio wave detection module for detecting an illegal radio device according to the present invention, the single frequency antenna, the radio signal processing unit, and the micro-controller are installed to be mounted on a circuit board of a device having a function for detecting the illegal radio device.

In the radio wave detection module for detecting an illegal radio device according to the present invention, the single frequency antenna, the radio signal processing unit, and the micro-controller are formed as a single chip.

In the radio wave detection module for detecting an illegal radio device according to the present invention, the single frequency antenna, the radio signal processing unit, and the micro-controller are formed as a single chip mounted on a chip socket that is installed on a circuit board of a device, which is provided with a separate system micro-controller to have a function for detecting an illegal radio device, to be contact with an IO port of the system micro-controller, so that the data value of a digital form outputted from the micro-controller is inputted into the system micro-controller.

In the radio wave detection module for detecting an illegal radio device according to the present invention, the single frequency antenna, the radio signal processing unit, and the micro-controller are installed to be contact with an external line connection terminal that is installed on a circuit board of a device, which is provided with a separate system micro-controller to have a function for detecting an illegal radio device, to be contact with an IO port of the system micro-controller, so that the data value of a digital form outputted from the micro-controller is inputted into the system micro-controller.

In the radio wave detection module for detecting an illegal radio device according to the present invention, the radio signal processing unit comprises: a band pass filter for extracting the radio signal of the frequency band used by the illegal radio device from the narrowband radio signal received through the single frequency antenna; and an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

According to another aspect of the invention, there is provided a mobile device having a radio wave detection function for detecting an illegal radio device that uses a radio signal of a designated frequency band, the mobile device comprising: a system micro-controller mounted with a program for performing the function for detecting an illegal radio device that uses a radio signal of a designated frequency band, for performing original functions of the mobile device; and a radio wave detection module connected to the system micro-controller to be supplied with power from a battery of the mobile device, for transmitting a result of detecting the illegal radio device to the system micro-controller, wherein the radio wave detection module is provided with a single frequency antenna selected from a group comprising a loop antenna, a micro-strip antenna, and a chip antenna, for receiving a narrowband radio signal including a radio signal of a frequency band used by the illegal radio device.

In the mobile device having a radio wave detection function for detecting an illegal radio device according to the present invention, the radio wave detection module comprises: a band pass filter for extracting a radio signal of a frequency band used by the illegal radio device from the narrowband radio signal received through the single frequency antenna; and an RF detector for extracting the specific frequency of the illegal radio device from the radio signal extracted through the band pass filter, and converting the extracted frequency into a direct current voltage value that is an electrical signal transmitted to an analog-to-digital converter port of the system micro-controller.

In the mobile device having a radio wave detection function for detecting an illegal radio device according to the present invention, the radio wave detection module comprises: a band pass filter for extracting a radio signal of a frequency band used by the illegal radio device from the narrowband radio signal received through the single frequency antenna; and an RF detector for extracting the specific frequency of the illegal radio device from the radio signal extracted through the band pass filter, and converting the extract frequency into a direct current voltage value; and a detection micro-controller for receiving the direct current voltage value obtained by the RF detector through an analog-to-digital converter port, converting the direct current voltage value into a data value of a digital form through an internal operation, and transmitting the data value of a digital form to the system micro-controller through an IO port of the system micro-controller.

In the mobile device having a radio wave detection function for detecting an illegal radio device according to the present invention, the radio wave detection module is formed as a single chip installed in a main body of the mobile device where the system micro-controller is installed.

The mobile device having a radio wave detection function for detecting an illegal radio device according to the present invention further comprises an external line connection terminal connected to the system micro-controller, wherein the radio wave detection module is installed in a constitutional part of the mobile device selected among a group comprising a battery, earphone, microphone, Bluetooth, and memory stick, and thus when the constitutional part of the mobile device is connected to the external line connection terminal, the radio wave detection module is connected to the system micro-controller and performs the function for detecting an illegal radio device.

In the mobile device having a radio wave detection function for detecting an illegal radio device according to the present invention, the radio wave detection module is installed to be mounted on a circuit board of the mobile device.

In the mobile device having a radio wave detection function for detecting an illegal radio device according to the present invention, the single frequency antenna of the radio wave detection module is installed to be formed in a shape of a pattern on an inner surface of a housing of the main body of the mobile device.

### INDUSTRIAL APPLICABILITY

According to a radio wave detection method and a radio wave detection module for detecting illegal radio devices, since a narrowband radio signal including a radio signal of a frequency band used by an illegal radio device is received using single frequency antennas and processed in serial, the illegal radio device can be detected with excellent stability and high response and detection efficiency compared with conventional techniques. Particularly, since a direct current voltage for a specific frequency of the illegal radio device is obtained through a serial process after receiving a narrowband radio signal including a radio signal of a frequency band used by the illegal radio device using single frequency antennas, a problem of making a mobile device unstable due to noises or erroneous signals inputted while processing the received signal can be effectively removed, and thus response and detection efficiency for the radio signal of the illegal radio device can be enhanced. In addition, in implementing an apparatus for detecting illegal radio devices, the present invention can be configured in a form of a module utilizing active elements and passive elements, and the module can be installed in a circuit board or configured as a single chip. Therefore, since the configuration is simplified compared with conventional techniques, the apparatus can be miniaturized, and a function for detecting illegal radio devices can be easily applied to a mobile device such as a cellular phone. In addition, since the present invention can be configured to output a data value of a digital form through the micro-controller (microcomputer) installed in itself, a hardware configuration for detecting a radio signal of an illegal radio device does not need to be additionally configured in a mobile device such as a cellular phone, and thus the present invention is highly compatible with a variety of mobile devices. Particularly, since the radio wave detection module according to the present invention can be configured as a single chip, a wave radio detection function for detecting illegal radio devices can be applied only by adding a configuration (a socket or an external line connection terminal) for combining a radio wave detection circuit to a desired mobile device such as a cellular phone, and thus burdens on designing a desired device to which the present invention is applied can be diminished. Furthermore, unlike conventional techniques, in the present invention, since a module having a radio wave detection function for detecting illegal radio devices can be added while diminishing burdens on designing a module of a mobile device, an illegal radio device can be detected stably and efficiently without deteriorating original functions of the mobile device. Particularly, since single frequency antennas are installed in addition to the antenna of the mobile device and a detection micro-controller for performing the radio wave detection function is configured in addition to the system micro-controller, the radio wave detection function is separated from the original functions of the mobile device to stably and efficiently perform the detection function, and the mobile device can smoothly perform its original functions. In addition, since single frequency antennas are installed in addition to the antenna of the mobile device, it is advantageous in that a modification of design for installing the antennas is not required to a mobile device that does not use an antenna, such as a calculator, digital camera, PSP, and the like.

Although the present invention has been described with reference to several preferred embodiments, the description is illustrative of the invention and is not to be construed as limiting the invention. Various modifications and variations may occur to those skilled in the art, without departing from the scope of the invention as defined by the appended claims.

1. A radio wave detection method for detecting an illegal radio device that uses a radio signal of a designated frequency band, the method comprising the steps of:
receiving a narrowband radio signal including a radio signal of a frequency band used by the illegal radio device through a single frequency antenna, and obtaining a direct current voltage value for a specific frequency of the illegal radio device by serially processing the received narrowband radio signal;
transmitting the obtained direct current voltage value to a micro-controller through an analog-to-digital converter port of the micro-controller, and outputting a data value of a digital form from the micro-controller; and
externally displaying existence of the illegal radio device through a display apparatus using the outputted data value of a digital form.

2. The method according to claim 1, wherein the step of obtaining a direct current voltage value for a specific frequency of the illegal radio device comprises the steps of:
extracting the radio signal of the frequency band used by the illegal radio device from the narrowband radio signal received through the single frequency antenna, using a band pass filter; and
extracting the specific frequency of the illegal radio device through an RF detector from the radio signal extracted through the band pass filter, and converting the extracted frequency into the direct current voltage value that is an electrical signal transmitted to the analog-to-digital converter port of the microcontroller.

3. The method according to claim 1, wherein the step of externally displaying existence of the illegal radio device through a display apparatus using the outputted data value of a digital form comprises the steps of:
transmitting the data value of a digital form outputted from the micro-controller to a system micro-controller through an input-output port (IO port) of the system micro-controller; and
externally displaying the data value of a digital form through the display apparatus under a control of the system micro-controller.

4. A radio wave detection module for detecting an illegal radio device that uses a radio signal of a designated frequency band, the module comprising:
a single frequency antenna selected from a group comprising a loop antenna, a micro-strip antenna, and a chip antenna, for receiving a narrowband radio signal including a radio signal of a frequency band used by the illegal radio device;
a radio signal processing unit for obtaining a direct current voltage value for a specific frequency of the illegal radio device by serially processing the narrowband radio signal received from the single frequency antenna; and
a micro-controller for outputting the direct current voltage value obtained from the radio signal processing unit as a data value of a digital form.

5. The module according to claim 4, wherein the single frequency antenna, the radio signal processing unit, and the micro-controller are installed to be mounted on a circuit board of a device having a function for detecting the illegal radio device.

6. The module according to claim 4, wherein the single frequency antenna, the radio signal processing unit, and the micro-controller are formed as a single chip.

7. The module according to claim 4, wherein the single frequency antenna, the radio signal processing unit, and the micro-controller are formed as a single chip mounted on a chip socket that is installed on a circuit board of a device, which is provided with a separate system micro-controller to have a function for detecting an illegal radio device, to be contact with an IO port of the system microcontroller, so that the data value of a digital form outputted from the microcontroller is inputted into the system micro-controller.

8. The module according to claim 4, wherein the single frequency antenna, the radio signal processing unit, and the micro-controller are installed to be contact with an external line connection terminal that is installed on a circuit board of a device, which is provided with a separate system micro-controller to have a function for detecting an illegal radio device, to be contact with an IO port of the system micro-controller, so that the data value of a digital form outputted from the micro-controller is inputted into the system micro-controller.

9. The module according to claim 4, wherein the radio signal processing unit comprises:
a band pass filter for extracting the radio signal of the frequency band used by the illegal radio device from the narrowband radio signal received through the single frequency antenna; and
an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

10. A mobile device having a radio wave detection function for detecting an illegal radio device that uses a radio signal of a designated frequency band, the mobile device comprising:
a system micro-controller mounted with a program for performing the function for detecting an illegal radio device that uses a radio signal of a designated frequency band, for performing original functions of the mobile device; and
a radio wave detection module connected to the system micro-controller to be supplied with power from a battery of the mobile device, for transmitting a result of detecting the illegal radio device to the system micro-controller, wherein the radio wave detection module is provided with a single frequency antenna selected from a group comprising a loop antenna, a micro-strip antenna, and a chip antenna, for receiving a narrowband radio signal including a radio signal of a frequency band used by the illegal radio device.

11. The mobile device according to claim 10, wherein the radio wave detection module comprises:
a band pass filter for extracting a radio signal of a frequency band used by the illegal radio device from the narrowband radio signal received through the single frequency antenna; and
an RF detector for extracting the specific frequency of the illegal radio device from the radio signal extracted through the band pass filter, and converting the extracted frequency into a direct current voltage value that is an electrical signal transmitted to an analog-to-digital converter port of the system micro-controller.

12. The mobile device according to claim 10, wherein the radio wave detection module comprises:
a band pass filter for extracting a radio signal of a frequency band used by the illegal radio device from the narrowband radio signal received through the single frequency antenna;
an RF detector for extracting the specific frequency of the illegal radio device from the radio signal extracted through the band pass filter, and converting the extract frequency into a direct current voltage value; and
a detection micro-controller for receiving the direct current voltage value obtained by the RF detector through an analog-to-digital converter port, converting the direct current voltage value into a data value of a digital form through an internal operation, and transmitting the data value of a digital form to the system micro-controller through an IO port of the system micro-controller.

13. The mobile device according to claim 10, wherein the radio wave detection module is formed as a single chip installed in a main body of the mobile device where the system micro-controller is installed.

14. The mobile device according to claim 10, further comprising an external line connection terminal connected to the system micro-controller, wherein the radio wave detection module is installed in a constitutional part of the mobile device selected among a group comprising a battery, earphone, microphone, Bluetooth, and memory stick, and thus when the constitutional part of the mobile device is connected to the external line connection terminal, the radio wave detection module is connected to the system micro-controller and performs the function for detecting an illegal radio device.

15. The mobile device according to claim 10, wherein the radio wave detection module is installed to be mounted on a circuit board of the mobile device.

16. The mobile device according to claim 10, wherein the single frequency antenna of the radio wave detection module is installed to be formed in a shape of a pattern on an inner surface of a housing of the main body of the mobile device.

17. The method according to claim 2, wherein the step of externally displaying existence of the illegal radio device through a display apparatus using the outputted data value of a digital form comprises the steps of:
transmitting the data value of a digital form outputted from the micro-controller to a system micro-controller through an input-output port (IO port) of the system micro-controller; and
externally displaying the data value of a digital form through the display apparatus under a control of the system micro-controller.

18. The module according to claim 5, wherein the radio signal processing unit comprises:
a band pass filter for extracting the radio signal of the frequency band used by the illegal radio device from the narrowband radio signal received through the single frequency antenna; and
an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

19. The module according to claim 6, wherein the radio signal processing unit comprises:
a band pass filter for extracting the radio signal of the frequency band used by the illegal radio device from the narrowband radio signal received through the single frequency antenna; and
an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

20. The module according to claims 7, wherein the radio signal processing unit comprises:
a band pass filter for extracting the radio signal of the frequency band used by the illegal radio device from the narrowband radio signal received through the single frequency antenna; and
an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

21. The module according to claims 8, wherein the radio signal processing unit comprises:
a band pass filter for extracting the radio signal of the frequency band used by the illegal radio device from the narrowband radio signal received through the single frequency antenna; and
an RF detector for extracting the specific frequency of the illegal radio device from the radio signal extracted through the band pass filter, and converting the extracted frequency into the direct current voltage value that is an electrical signal transmitted to the analog-to-digital converter port of the micro-controller.

22. The mobile device according to claims 11, wherein the radio wave detection module is formed as a single chip installed in a main body of the mobile device where the system micro-controller is installed.

23. The mobile device according to claims 12, wherein the radio wave detection module is formed as a single chip installed in a main body of the mobile device where the system micro-controller is installed.

24. The mobile device according to claims 11, further comprising an external line connection terminal connected to the system micro-controller, wherein the radio wave detection module is installed in a constitutional part of the mobile device selected among a group comprising a battery, earphone, microphone, Bluetooth, and memory stick, and thus when the constitutional part of the mobile device is connected to the external line connection terminal, the radio wave detection module is connected to the system micro-controller and performs the function for detecting an illegal radio device.

25. The mobile device according to claims 12, further comprising an external line connection terminal connected to the system micro-controller, wherein the radio wave detection module is installed in a constitutional part of the mobile device selected among a group comprising a battery, earphone, microphone, Bluetooth, and memory stick, and thus when the constitutional part of the mobile device is connected to the external line connection terminal, the radio wave detection module is connected to the system micro-controller and performs the function for detecting an illegal radio device.

26. The mobile device according to claims 11, wherein the radio wave detection module is installed to be mounted on a circuit board of the mobile device.

27. The mobile device according to claims 12, wherein the radio wave detection module is installed to be mounted on a circuit board of the mobile device.

28. The mobile device according to claims 11, wherein the single frequency antenna of the radio wave detection module is installed to be formed in a shape of a pattern on an inner surface of a housing of the main body of the mobile device.

29. The mobile device according to claims 12, wherein the single frequency antenna of the radio wave detection module is installed to be formed in a shape of a pattern on an inner surface of a housing of the main body of the mobile device.
